(19) United States
(12) Patent Application Publication
(10) Pub. No.: US 2026/0274764 A1
(43) Pub. Date: Sep. 17, 2026

(54) Method And Production System For The Manufacture Of Artificial Aglomerate Material Slabs

(71) Applicant: COSENTINO RESEARCH & DEVELOPMENT, S.L., Cantoria, Almería (ES)

(72) Inventors: Diego Pérez Mena, Almería (ES); Francisco Jesús Linares Menchón, Almería (ES); María Jesús Ayuso Sánchez, Almería (ES)

(73) Assignee: COSENTINO RESEARCH & DEVELOPMENT, S.L., Cantoria, Almería (ES)

(21) Appl. No.: 19/580,500

(22) PCT Filed: Oct. 25, 2024
(86) PCT No.: PCT/EP2024/080213

§ 371 Date: Apr. 21, 2026

(30) Foreign Application Priority Data
Oct. 25, 2023 (EP) 23383093.4

(51) Int. Cl. C04B 41/45; C04B 41/00; C04B 41/52; C04B 41/70

(52) U.S. Cl. CPC C04B 41/4576; C04B 41/009; C04B 41/4578; C04B 41/52; C04B 41/70

(57) ABSTRACT

The present disclosure is related to a method and a system for manufacturing slabs of artificial agglomerate material with novel aesthetic effects. A slab manufactured by the method is also claimed and may be used for counters, kitchen tops, sinks, shower trays, wall cladding, flooring or the like. The method comprises the following steps: dispensing a first layer of a first mixture onto a surface; creating groove(s) in the first layer; dispensing a second mixture inside the groove(s); dispensing a third mixture inside the groove(s); wherein the first, second and third mixture are all different mixtures, each comprising 85-95% wt of a particulate material and 5-15% wt of a binder; and compacting and hardening the combination of first, second and third mixtures.

### FIELD OF THE DISCLOSURE

The present disclosure is related to a method for manufacturing slabs of artificial agglomerate material with novel aesthetic effects. Also, the present disclosure is related to the system for the manufacture of said slabs of artificial agglomerate material and the artificial agglomerate material slab manufactured according to the method.

The disclosure falls in the field of materials for construction, decoration and architecture, made of artificial stone, as well as to their manufacture and fabrication. Particularly, the disclosure falls within the technological area of artificial agglomerate stone slabs having chromatic effects and decorations, used as surfaces for counters, kitchen tops, sinks, shower trays, wall cladding, flooring, or the like.

### BACKGROUND OF THE DISCLOSURE

Artificial agglomerate stone slabs, tiles or sheets frequently simulate natural stones and are common in the construction, decoration, architecture, and design sectors. The habitual processes for manufacturing theses slabs, tiles or sheets at industrial scale are well established nowadays.

One of the most popular artificial stone materials and highly appreciated for their aesthetic, hardness and resistance to staining and wear, are the so-called quartz agglomerate surfaces, mineral agglomerate surfaces, or engineered stone surfaces. These stone materials are extensively used for countertops, claddings, floorings, sinks and shower trays, to name a few applications. Also, they can be more generally called artificial agglomerate stones. Offering superior performance, these materials are an improved alternative to natural stones such as marble or granite in their traditional applications.

Artificial agglomerate stones can be made simulating colors and patterns in natural stone or they might also have a totally artificial appearance, e.g., with plain bright red or fuchsia colors. The basis of their composition and the technology currently implemented for manufacturing the artificial agglomerate stones dates back from the late 1970s, as developed by the company Breton SpA which is nowadays commercially known in the sector under the name Bretonstone®.

General concepts of the manufacturing of artificial agglomerate stones are known and disclosed, for example, in the patent document U.S. Pat. No. 4,204,820A. In their production process, inorganic (stone, mineral or synthetic) granulates and powders-commonly quartz, synthetic cristobalite and/or other mineral granulates-having varied particle sizes, are firstly mixed with a hardenable binder, frequently a liquid organic resin. The resulting mixture is homogenized and distributed into a temporary mold or alternatively onto a sheet of paper, where it is then compacted by vibrocompaction under vacuum and subsequently hardened.

Recently, there has been an increasing demand for this type of products, in particular the versions which are imitations of natural marble slabs. Some of those marble slabs, such as Calacatta or Statuario, are characterized by having relatively wider veins of a material of different color than the background material, showing veins which extend through different distances in the length and/or the width of the slab, and which are visible partially or fully through the thickness of the slab.

In order to simulate the appearance of these natural stones in artificial agglomerate materials, a frequent approach has been to use combinations of different types of pigmented (unhardened) mixtures, which are separately distributed on a surface before compaction and hardening steps.

Different strategies have been described for the separated distribution of the different pigmented mixtures. In some cases, as described in WO 2019101823 A1, a template might be used to create cavities in a layer of a first mixture, and then filling the cavities with a second mixture different than the first mixture. Alternatively, as described e.g. in EP 3486052 A1, a tool can be used to mechanize a layer of first mixture to create a furrow or a cavity. A second mixture is normally subsequently filled into the cavities. It has also been known to fill different separated mixtures into different cavities.

Consumers have different preferences regarding the final appearance of artificial agglomerate material slabs. While some of them would appreciate artificial agglomerate materials resulting from the application of the strategies mentioned above for creating veined effects in these materials, others would prefer other chromatic combinations or effects.

Therefore, there is a need in the art for providing an improved method for manufacturing a slab of artificial agglomerate material, in an industrial efficient and highly reproducible way, resulting in new types of aesthetic effects that while still maintain some resemblance to, and therefore also the appeal of, the patterns found in some natural marble and other veined natural stone materials, they offer richer chromatic vein decorations.

### DESCRIPTION

The disclosure herein provides a solution for the above-mentioned issues by a method for manufacturing a slab of artificial agglomerate material according to claim 1, a system for the manufacture of slabs according to claim 10 and an artificial agglomerate material or slab according to claim 12. In dependent claims, embodiments of certain aspects covered by the disclosure are defined.

The artificial agglomerate material can be a synthetic solid agglomerate surface or stone, a mineral agglomerate surface or stone, or an engineered stone, as described herein and as such terms are generally understood in the technical field of the disclosure. For clarity purposes, but without intending to be limiting, the terms agglomerate material, agglomerate stone or artificial agglomerate material or stone, refer herein at least to all materials included in the definition of agglomerate stone contained in European standard EN 14618:2009.

The artificial agglomerate material in embodiments of the different aspects is in the form of a slab and the term slab shall be understood to cover also tile, sheet, plank, board, or plate. Moreover, the term slab covers artificial material blocks which have a major dimension of at least 20 times its thickness.

In some embodiments, the slab of artificial agglomerate material has a surface, such as at least one of its major surfaces, polished, brushed, honed, buffed or sanded. In some embodiments, the slab of artificial agglomerate material has at least a polished surface, e.g., one or both of its largest surfaces.

The skilled person readily understands that, when a composition or material is defined by the weight percentage values of all the components it comprises, these values can never sum up to a value which is greater than 100%. The amount of all components that said material or composition comprises adds up to 100% of the weight of the composition or material. When the amount of a component of a composition, mixture or material is given by a range with a lower limit of 0, 0 wt %, 0.0 or 0.0 wt %, this means that said composition, mixture or material may either not comprise said component or comprise it in an amount not higher than the specified upper limit of the range. In the present disclosure, the described percentages refer to w/w percentage unless otherwise stated.

When a range is indicated in the present document, both lower and upper limits are included in said range.

In the context of the present disclosure, a groove region provides a cavity with a specific volume.

The expressions “obtainable”, “obtained” and equivalent expressions are used herein interchangeably, and in any case, the expression “obtainable” encompasses the expression “obtained”.

Unless specifically stated otherwise, or unless they are clearly incompatible, all the embodiments disclosed in relation to an aspect of the disclosure are also applicable to the other aspects. It should be understood that the scope of the present disclosure includes all the possible combinations of embodiments disclosed herein, either belonging to the same aspect or to different aspects of the disclosure.

The term ‘binder’ is understood in the art and hereby refers to a component that performs the function of holding together a particulate material or ‘filler’ to form the artificial agglomerate material. The binder is unhardened or uncured when mixed with the particulate material, and it is subsequently hardened or cured to produce a hardened binder which gives cohesion and mechanical strength to the artificial agglomerate material.

In a first aspect, the disclosure provides a method for manufacturing a slab of artificial agglomerate material comprising the following steps:
a) dispensing a first layer of a first mixture onto a first surface, the first mixture comprising 85-95 wt % of a first particulate material and 5-15 wt % of a first binder material, the first layer having a first thickness h;
b) creating at least one groove in the first layer extending at least partially through the first thickness h of the first layer, the at least one groove comprising one first groove region,
c) dispensing a second mixture comprising 85-95 wt % of a second particulate material and 5-15 wt % of a second binder material into the first groove region;
   wherein the method comprises:
dispensing into the first groove region a third mixture, the third mixture comprising 85-95 wt % of a third particulate material and 5-15 wt % of a third binder material,
the first mixture, the second mixture and the third mixture being all different mixtures, and
   the method further comprising the step:
d) compacting and hardening the combination of first, second and third mixtures.

Advantageously, the method of the first aspect, according to the embodiments presented herein, provides a novel manner of manufacturing artificial agglomerate material such as the artificial agglomerate stone slabs showing novel aesthetic effects in the top or lower major surface of the slab, as well as through its thickness. The aesthetic effects in the thickness are visible at the edges of the slab, e.g. when the slab is cut-to-size and installed for the intended application.

The method encompasses dispensing a first layer of a first mixture onto a first surface. The first mixture comprises 85-95 wt % of a first particulate material and 5-25 wt % of a first binder material, both related to the weight of the first mixture.

The first layer may have a shape corresponding to the artificial agglomerate material slab being manufactured, normally with some excess in its dimensions to compensate for the shrinkage that may be produced during compacting and hardening. The average thickness of this first layer herein denoted as h, and may range from 10-200 mm, or 15 -100 mm.

At least one groove is created in the first layer of first mixture. The at least one groove may be created by a first grooving device. The at least one groove may extend partially through the thickness h of the first layer. The at least one groove may also extend completely through the thickness h of the first layer.

The at least one groove may include multiple grooves, such as 2-10 grooves, intersecting or not. The at least one groove may extend through the length and width of the first layer, following more or less regular paths, and may extend from edge-to-edge of the first layer, such as, for example, through the full length or through full width of the first layer.

The at least one groove define a first groove region, meaning a portion or the whole of the at least one groove being created. The first groove region may be continuous or discontinuous along the path followed by the at least one groove and might encompass a smaller or larger portion of the at least one groove. The first groove region length may range 1-350 cm, or 5-150 cm. In some embodiments, the first groove region length may range 1-80 cm, or 2-60 cm. The first groove region may have an average width at its side more distal from the first surface, understood as the average of width at different points along the length of the groove region, ranging 2-20 cm, or 5 -15 cm, or 5-10 cm. The width of the first groove region may vary along the thickness of the first layer, or along the length of the first groove region. In embodiments, the first groove region has an elongated shape, such that the length of the at least first groove region is at least 3 times, at least 5 times or at least 10 times, its average width. In embodiments the first groove region may substantially extend through the whole path defined by one or several grooves of the at least one groove. As the at least one groove, the first groove region may extend partially or completely through the thickness h of the first layer.

A first template may be used to create the at least one groove in the first layer. The first template, and the form/forms it might comprise, can have any desired shape or combination of shapes, and may define any desired pattern. Different templates for creating the at least one groove in the first layer are possible and inside the scope of this disclosure. Also, more than one template can be used. Non-limiting examples of templates useful for the method of the disclosure are described in document WO2019101823A1.

According to some embodiments, both second and third mixtures are dispensed in the (same) first groove region. In other words, after dispensation of the second and third mixtures, the first groove region comprises both second and third mixtures. In some embodiments, the third mixture is dispensed subsequently after the second mixture has been dispensed.

The first, second and/or third particulate materials may be inorganic, and may comprise stone, stone-like and ceramic materials, such as quartz, silicate glass (virgin, frit or recycled), silica sand, feldspar, feldspathic sand, mirror, granite, basalt, (synthetic) cristobalite, dolomite or porcelain ceramic, and mixtures thereof; or silicate glass (virgin, frit or recycled), feldspar, or porcelain ceramic and mixtures thereof. The first, second and/or third binder may be an organic resin, hydraulic cement based or a geopolymer based material. The first, second and/or third mixtures may comprise one or several colorants (such as pigments or dyes) so that each mixture has the desired coloration.

The first, second and third binder may be of similar chemical nature, so as to be compatible and perform similarly during processing and during handling/use of the slab being manufactured. The first, second and third binder may be different or identical organic resins, such as translucent organic resins. The organic resin, within the concept of the disclosure, may be thermosetting or thermoplastic. In certain embodiments, the organic resin is thermosetting, for example, an unsaturated polyester resin, an acrylic resin, a vinyl resin, or an epoxy resin. In some embodiments, the organic resin is an unsaturated polyester resin. For example, the first binder, the second binder and the third binder may comprise the same type of polymer, monomer or combination of those, such as they both may comprise a polyester pre-polymer diluted in styrene.

The first binder, the second binder and/or the third binder may be liquid or at least shall have some capacity to flow during the mixing with the respective particulate material, during dispensation of the mixtures, and/or during the compaction steps. All three binders may produce, after hardening, hardened binders, which function holding (binding) the particulate materials together in the form of a slab.

Additionally, additives, such as colorants, curing catalysts, curing accelerators, adhesion promoters (e.g., silanes), antimicrobial agents, ultraviolet stabilizers, rheology modifiers, or mixtures thereof, can be included in the first, second and/or third mixtures. These types of additives and the proportion used thereof, are known in the state of the art. In some embodiments, these additives may be present in the first, second and/or third mixtures in an amount of 0.01 weight percent-5 wt %, based on the weight of the respective mixture.

The combination of first, second and third mixtures can be then covered with a protective film or similar on its exposed surfaces and subjected to compaction, such as by vacuum vibrocompaction. Compaction may be conducted with a compacting station or a vacuum vibrocompacting station. The compacting station may comprise a press. Other forms of achieving compaction are possible and inside the scope of the present disclosure.

For the purpose of vacuum vibrocompacting, in an example, the combination of first, second and third mixtures, may be conveyed inside a compaction zone of a compaction station, e.g. comprising a press, wherein it is introduced into a sealable chamber. The chamber is then sealed and vacuum is created with suitable exhaust pumps. Once the desired vacuum level (e.g., 5 mbar-40 mbar) is reached, the station or press ram exerts a compaction pressure simultaneously with the application of a vertical vibration of the ram (e.g., oscillating at 2.000 Hz-4.000 Hz). During vacuum vibrocompaction, the air trapped in first, second and third mixtures is substantially evacuated.

In certain embodiments, once compacted, the combination of first, second and third mixtures proceeds to a hardening (or curing) stage. In this stage, depending on the type of binder, as well as the use or not of any optional catalysts or accelerants, the compacted material may be subjected to the effect of temperature. Alternatively, the compacted material may be left to cure at room temperature. The compacted combination of first, second and third mixtures may be subjected to the effect of temperature in a hardening station (curing kiln or oven), suitably heated to 40° C.- 120 ° C., with residence times in the oven that can vary between 10 minutes and 90 minutes. Other types of hardening and curing are possible and within the present disclosure, such as hardening by application of radiation, such as UV-radiation.

In some embodiments, the obtained slab of agglomerate material is allowed to cool down after the hardening stage.

After hardening and, given the case, cooling, the slab of artificial agglomerate material obtained can be cut and/or gauged to the desired final dimensions. Further, the slab of artificial agglomerate material may be finished (polished, honed, etc.) on one or both of its larger surfaces, depending on the intended application.

After compacting and hardening, a slab is obtained comprising a combination of first hardened mixture, second hardened mixture and third hardened mixture. In certain embodiments, the first, second and third hardened mixtures are different, meaning that they have different composition, different particulate material particle size distribution, or are visually distinguishable from each other.

In some embodiments, the second mixture is disaggregated before it is dispensed into the first groove region.

Advantageously, disaggregating the second mixture before dispensing helps avoiding formation of any lumps, clumps, or similar, of the second mixture and to enhance the accuracy of the adjustment of the amounts, and the precision of the discharge, of second mixture dispensed in different portions of the at least one groove in the first layer.

In some embodiments, the third mixture is dispensed over (or on top of) the second mixture previously dispensed in the first groove region. Therefore, the third and second mixtures are in contact, such as forming separated layers, in the obtained artificial material.

In some embodiments, the at least one groove extends through the entire thickness h of the first layer.

In some embodiments of the method of the first aspect, the second mixture fills less than 60 % v/v, such as 10-60 % v/v, or such as 20-50% v/v of the volume of the cavity defined by the first groove region of the at least one groove.

In some embodiments of the method of the first aspect, the second and third mixture both form layers, wherein the third mixture layer is arranged on top of and in contact with the second mixture layer. In embodiments, the third mixture layer projection onto the first surface along the thickness direction of the first layer overlaps with the equivalent projection of the second mixture layer in 30-100 %, such as 50-100 %.

In these embodiments, the layered distribution of different mixes, including with different coloration, in the at least one groove is visible in the edges of the slab being manufactured, or the visible edges resulting from cutting through the first groove region in such slabs, contributing to a richer and more appealing veined decoration of these edges.

In some embodiments of the first aspect of the disclosure, the third mixture is dispensed into the first groove region over the previously deposited second mixture. In embodiments, the third mixture does not contact the first surface. In embodiments, the third mixture contacts one or both opposed walls of the first groove region in the first layer.

In some embodiments of the first aspect, the second mixture is dispensed in the first groove region covering in average 40-100 %, or 60-100 % of the width of the cross-section of the first groove region. In some other embodiments, the third mixture is dispensed in the first groove region covering in average 40-100%, or 60-100% of the cross-section of the first groove region where it is dispensed.

In some embodiments of the method of this aspect of the disclosure, the third mixture fills less than 60%, such as 10-60 %, or such as 20-50% of the volume of the cavity defined by the first groove region.

In some embodiments of the method of the first aspect, the added amounts of second mixture and third mixture fills less than 90% v/v, such as 10-90% v/v, or less than 75% v/v, such as 20-75% v/v, of the volume of the cavity defined by the first groove region.

By not filling completely the volume of the cavity defined by the first groove region, it is aimed that the cavity partially collapses during compaction, that the cavity walls have space to come closer, and thus altering partially the arrangement of second and third mixtures in the veins of the slab being manufactured. The alteration adds an effect of provoked randomness to the veins, visible at the exposed slab surface or at the edges created when the slab is cut.

In some embodiments of the method, the weight amount of second mixture dispensed into the first groove region is 1-50% higher, or 1-30% higher, than the weight amount of third mixture dispensed in the first groove region. In additional embodiments, the amount in weight of second mixture dispensed into the first groove region is 5-50 % higher, or 5-30 % higher, than the amount in weight of third mixture dispensed in the first groove region.

In some embodiments of the method the first mixture, the second mixture and the third mixture are different mixtures.

Advantageously, dispensing three different mixtures helps providing an even broader range of aesthetic effects in the top or lower major surface of the slab, as well as in its thickness.

In some embodiments, the second mixture and the third mixture may have different composition, or different particulate material particle size distribution, or both. In non-limiting embodiments, the second and third mixtures are selected to be visually distinguishable in the slabs being manufactured, at least after compacting and hardening.

In a second aspect, the disclosure provides a system for the manufacture of slabs (5) of artificial agglomerate material, for example, configured for implementing the method of any of the preceding claims, wherein the system comprising:
a first mixer configured for providing a first mixture comprising 85-95 wt % of a first particulate material and 5-15 wt % of a first binder,
a first dispenser suitable for dispensing a first layer of the first mixture on a first surface,
a first grooving device configured for the creation of at least one groove extending at least partially in the first layer, the at least one groove comprising one first groove region,
a second mixer configured for providing a second mixture comprising 85-95 wt % of a second particulate material and 5-15 wt % of a second binder,
a second dispenser suitable for the dispensation of the second mixture, the second dispenser being mounted on a first robotic device which is configured to move the second dispenser to the first groove region,
a compacting station, and
a hardening station,
   wherein the system further comprises:
a third mixer configured for mixing a third mixture comprising 85-95 wt % of a third particulate material and 5-15 wt % of a third binder,
a third dispenser for the dispensation of the third mixture, the third dispenser being mounted on a second robotic device configured to move the third dispenser to the first groove region;
the first, second and third mixers being all different mixers.

The first surface according to the different aspects might be embodied by a sheet of kraft paper or plastic, which can be arranged on top of a conveyor or other part of a production line. In non-limiting embodiments, the first surface is part of a temporary mold, for instance, the bottom of a tray-shaped mold, which is used to retain the first mixture during the manufacturing of the slab.

The first particulate material and the first binder may be mixed in a first mixer, such as a planetary mixer. The first mixture can be transported, for instance by a conveyor, from the first mixer and dispensed onto a first surface by means of a first dispenser. Devices suitable as first dispenser are, for instance, the dispenser devices generally known for the dispensing of (unhardened) agglomerate mixtures in the manufacture of mineral or quartz agglomerate surfaces. The first dispenser, in examples, may comprise a feeding first hopper that receives the first mixture from the first mixer through its top opening and a first conveyor belt positioned below the bottom outlet opening of the first hopper, which collects and/or extracts the first mixture from the first hopper and deposits it onto the first surface. However, other configurations of the first dispenser are possible within the general concept of the disclosure.

In some embodiments, the first disperser may be movable along the length (this is, the longest dimension) of the first surface, which suitably corresponds to the length (or longest dimension) of the slab being manufactured. Also for example, the first disperser may deposit the first mixture covering the full width of the slab being manufactured, as it moves along the length of the first surface. The deposition of the first mixture forms the first layer on top of the first surface, which may have an essentially homogeneous thickness.

In some embodiments, the first grooving device may be a first template. The first template may comprise one or a several forms- or shapes-defining a pattern corresponding to the at least one groove to be created in the first layer. The form or forms may be, for example, mounted in a framed structure comprised in the first template. The form or forms may define a contour and might be solid or hollow bodies. According to certain embodiments, to create the at least one groove in the first layer, the first template may be positioned over the first surface before the first mixture is dispensed onto it. By removing the first template—once the first mixture is dispensed—the at least one groove is created in the first layer where the form or forms were located.

In another embodiments, the at least one groove in the first layer may be created by means of a first grooving device in the form of a wheel-shaped indenter. The wheel-shaped indenter may be inserted from the exposed upper side of the first layer, at least partially into its thickness h, and moved—while being inserted—through the first layer (e.g. by the indenter being coupled to the end of a robotic device that moves it following programmed paths).

In non-limiting embodiments, the wheel-shaped indenter might be shaped as two frustums of right cones joined by their bases, having a rotation axis coinciding with their frustum axes, with a maximal wheel width at the location of the rotation axis. Other shapes and designs of the indenter are possible and inside the general scope of the disclosure.

Other ways for creating the at least one groove in the first layer are possible and inside the general concept of the disclosure. For example, the at least one groove might be created by a first grooving device embodied as at least one (non-rotating) insert, or a combination of inserts, which is introduced from the upper exposed side of the first layer at least partially into its thickness. This may be achieved by arranging the at least one insert or combination of inserts over exposed upper side of the first layer, as it rests onto the first surface, and then moving it down until the insert or combination of inserts penetrated the desired depth into the first layer. By raising the at least one insert or combination of inserts to its original position (or by lowering the position of the first layer), at least one groove may be created into the first layer, with shapes and paths corresponding to the shapes and paths of the at least one insert or combination of inserts. The insert or combination of inserts might be-individually or collectively-inserted partially or fully through the first thickness of the first layer.

In some embodiments, the at least one groove might be created by a first grooving device configured to remove part of the first mixture from specific locations in the first layer. The first grooving device may comprise, for instance, an aspirating device (such as a hose connected to an aspirator) which is moved (e.g., by a robotic device) over the first layer as the first mixture under the aspirating device gets suctioned or aspirated.

In aspects of the present disclosure, it is envisaged the dispensing of a second mixture by a second dispenser into the first groove region of the at least one groove created in the first layer. The second mixture may be obtained by mixing in a second mixer 85-95 wt % of a second particulate material and 5-25 wt % of a second binder material. The first mixer may be different from the second mixer. The second mixture may be transported from the second mixer to the second dispenser by a conveyor. The second dispenser can have different configurations without departing from the scope of the general concept of the disclosure.

In some embodiments, the second dispenser is moved over the first layer to the first groove region of the at least one groove in the first layer. This can be achieved by the second dispenser being mounted on a first robotic device, such as a robotic arm or a cartesian robot, configured to move the second dispenser to the first groove region. The movement of the second dispenser and the amount of the second mixture dispensed in any location over the first layer can be controlled and/or synchronized, so that the second mixture is dispensed into the first groove region. This can be achieved by controlling both the second robotic device and the second dispenser automatically, e.g. by a computer program ran in a control unit. The second dispenser may be moved by the first robotic device following the paths defined by the at least one groove or the first groove region, as it dispenses the second mixture. In some embodiments, the second mixture is dispensed by the second dispenser in a localized way, or preferentially, in the at least one groove, and for example, 80-98 wt %, or 80-95 wt % of the second mixture may be dispensed inside the at least one groove, with 2-20 wt %, or 5-20 wt % of the second mixture possibly dispensed outside the at least one groove. The second mixture may be dispensed by the second disperser in a localized way, or preferentially in the first groove region or the at least one groove, without using any mask, template, or similar device for blocking the dispensation of the second mixture from the second dispenser into regions outside the first groove region and/or the at least one groove.

The second dispenser for depositing the second mixture, e.g. preferentially, into the first groove region can be, for example, any of the distributors mounted on a robotic device disclosed in the document WO 2019101823 A1. The second dispenser for the second mixture can comprise a feeding hopper that receives the second mixture from the second mixer in the top inlet opening thereof, and a belt positioned under the bottom outlet opening of the hopper, which collects and/or extracts the second mixture from the hopper and deposits it into the at least one groove.

Additionally, or alternatively, to the other embodiments, the second dispenser may comprise a disaggregating device for disaggregating any lumps, clumps, or similar, of the second mixture and to enhance the accuracy of the adjustment of the amounts of second mixture dispensed in different portions of the at least one groove in the first layer. The disaggregating device might be a rod provided with protruding prongs which, when the rod is rotated, interacts mechanically with the second mixture disaggregating it, e.g. as it is transported on top of the belt from the hopper to the discharge area.

The second disperser may comprise a funnel for collecting and focusing the second mixture being dispensed preferentially into the first groove region or the at least one groove. The funnel may be located next to the area where the second mixture is discharged from the belt towards the at least one groove. The funnel may be configured to have an inlet opening where the second mixture is discharged from the belt under the hopper. The funnel may also have an outlet opening from which the second mixture is dispensed into the first region or the at least one groove, as the second dispenser moves following the paths of this first region or at least one groove.

The configuration of the second dispenser mounted on the first robotic device of some of the embodiments disclosed here allow for a precise control of the amount of second mixture dispensed into the first groove region, e.g. by controlling the movement of the belt under the hopper of the second dispenser and the position and movement speed of the first robotic device. In fact, the amount of second mixture dispensed into different zones along the length of the first groove region can be controlled. In some embodiments of the production system, the second dispenser is arranged to dispense different amounts of second mixture in different zones along the first groove region. The amount of second mixture dispensed in a first zone of the first groove region may be different to the amount of second mixture dispensed in a second zone of the first groove region, the amount dispensed in the first zone being at least 10 wt %, or at least 20 wt % higher than the amount dispensed in the second zone.

Other configurations of the second dispenser and other methods for dispensing the second mixture into the at least one groove and the first groove region formed in the first layer are possible, and inside the scope of the disclosure.

The third mixture may be prepared in a third mixer, such as a planetary mixer, by mixing 85-95 wt % of a third particulate material and 5-15 wt % of a third binder. In some embodiments, the third mixer may be different from the second mixer and/or from the first mixer.

The third mixture may be dispensed into the first groove region of the at least one groove created in the first layer. The third mixture may be dispensed using a third dispenser mounted on a second robotic device. In some embodiments, the second robotic device is configured to move the third dispenser to the first groove region. In some embodiments, the third mixture is dispensed by the third dispenser in a localized way, or preferentially, in the at least one groove, and for example, 80-98 wt %, or 80-95 wt % of the third mixture may be dispensed inside the at least one groove, with 2-20 wt %, or 5-20 wt % of the third mixture possibly dispensed outside the at least one groove. The third mixture may be dispensed by the third disperser in a localized way, or preferentially in the first groove region or the at least one groove, without using any mask, template, or similar device for blocking the dispensation of the third mixture from the third dispenser into regions outside the first groove region and/or the at least one groove.

In some embodiments, the third dispenser is moved by the second robotic device over the first layer to the first groove region of the at least one groove in the first layer. The movement of the third dispenser and the amount of the third mixture dispensed in any location over the first layer can be controlled and/or synchronized, so that the third mixture may be dispensed in a localized manner, or preferentially, into the first groove region. This can be achieved by controlling both the second robotic device and the third dispenser automatically, e.g. by a program run in a computer control unit.

In some embodiments, the third dispenser is arranged to dispense different amounts of third mixture in different zones along the first groove region or the at least one groove. The amount of third mixture dispensed in a first zone of the first groove region may be different to the amount of third mixture dispensed in a second zone of the first groove region, the amount dispensed in the first zone being at least 10 wt %, or at least 20 wt % higher than the amount dispensed in the second zone.

Additionally, or alternatively, to the other embodiments, the third disperser may comprise a disaggregating device for disaggregating any lumps, clumps, or similar, of the third mixture and to enhance the accuracy of the adjustment of the amounts of third mixture dispensed in different portions of the at least one groove in the first layer. The disaggregating device might be a rod provided with protruding prongs which, when the rod is rotated, interacts mechanically with the second mixture disaggregating it, e.g. as it is transported on top of the belt from the hopper to the discharge area.

The second robotic device may be robotic arm or a cartesian robot. Features and characteristics of embodiments disclosed in relation to the first robotic device and second dispenser also apply to the second robotic device and the third dispenser.

The second robotic device, in some embodiments, may be the same as the first robotic device. For example, the second and third dispensers may be both mounted on the same robotic device. The second and third mixtures can be transported separately from the respective second and third mixers, and might be separately kept, for instance in separated hoppers, and dispensed separately, e.g. by separated belts, by the second and third dispensers. In other embodiments, the first and second robotic devices are different. In the case the first and second robotic devices are different, they may be located in separated stations along the production system or line, such as the second robotic device being located downstream from the first robotic device.

In a third aspect, the disclosure provides a slab of artificial agglomerate material manufactured according to any embodiment of the first aspect of the present disclosure, comprising:
a first major slab surface and a second major slab surface,
the first major slab surface comprising at least one vein extending at least partially through the thickness of the slab, and the first major slab surface comprising a first hardened mixture, the first hardened mixture comprising 85-95 wt % of a first particulate material and 5-15 wt % of a first hardened binder,
the at least one vein comprising a first vein portion exposed on the first major slab surface, wherein the first vein portion is extending at least partially through the thickness of the slab,
the first vein portion comprising a second hardened mixture, the second hardened mixture comprising 85-95 wt % of a second particulate material and 5-15 wt % of a second hardened binder,
   wherein
the first vein portion further comprises a third hardened mixture, the third hardened mixture comprising 85-95 wt % of a third particulate material and 5-15 wt % of a third hardened binder,
the first, second and third hardened mixtures being different.

This third aspect of the disclosure relates to a slab of artificial agglomerate material, which may be manufactured by the method or, for example, with the production system of the other aspects of this disclosure, and their different embodiments. The term slab is intended to cover tile, sheet, board, plate, plank, and in general an essentially flat and uniform thickness article, such as of square or rectangular parallelepiped form. In some embodiments, the dimensions of the slab may be at least 1500 mm in length, at least 1000 mm in width and 4 to 40 in thickness; such as 200 mm to 3500 mm in length, 1000 mm to 1800 mm in width and 4 mm to 40 mm in thickness. The slab normally comprises a first major slab surface and a second major slab surface opposed to the first major slab surface through the thickness of the slab.

In some embodiments, the slab may comprise a first pattern of a first hardened mixture exposed on the first major slab surface. The first hardened mixture might extend partially or fully through the thickness of the slab. The first hardened mixture may comprise 85-95 wt % of a first particulate material and 5-15 wt % of a first hardened binder. The first hardened mixture may be obtained by hardening the first mixture of the other aspects and embodiments of this disclosure.

The slab may also comprise a second pattern exposed on the first major slab surface of the slab. The second pattern defines at least one vein, the at least one vein (such as an elongated line or elongated band) comprising a first vein portion exposed on the first major slab surface. The first vein portion may be an elongated section and/or have variable length, the length possibly ranging 1-350 cm, or 5-150 cm. In some embodiments, the first vein portion length may range 1-80 cm, or 2-60 cm. The first vein portion might have an average width of 0.5-10 cm, or 1-7 cm.

In embodiments, the first vein portion has an elongated shape, such that the length of the first vein portion is at least 5 times, or at least 10 times, its average width. The first vein portion might extend partially or fully through the thickness of the slab.

In some embodiments, the first vein portion comprises a second hardened mixture and a third hardened mixture. The second hardened mixture may comprise 85-95% of a second particulate material and 5-15 of a second hardened binder. The third hardened mixture may comprise 85-95% of a third particulate material and 5-15 of a third hardened binder.

In certain embodiments, the first, second and third hardened mixtures are different, meaning that they have different composition, different particulate material particle size distribution, or are visually distinguishable from each other.

In some embodiments of the third aspect, the second hardened mixture makes less than 60 % v/v, such as 10-60 % v/v, or such as 20-50% v/v of the volume of the first vein portion.

In some embodiments of the third aspect, the second and third hardened mixtures in the first vein portion are arranged as separated layers. The separated layers of second and third hardened mixtures may overlap or contact in 30-100 %, preferably 50-100 %, wherein the overlapping is measured as the overlapping area of the projection of each layer of second and third hardened mixtures along the thickness direction of the first layer.

In some embodiments of the third aspect, the third hardened mixture occupies in average less than 60 %, such as 10-60 %, or such as 20-50% of the cross-section of the first vein portion.

In some embodiments, the first vein portion of the first major slab surface comprises third hardened mixture at least partially surrounded by the second hardened mixture, such as on both opposed sides, though the width of the first vein portion.

In some embodiments of the third aspect, the amount of second hardened mixture in the first vein portion is 0 -50 % higher, or 0 -30 % higher, or 1-50% higher, or 1-30% higher, or 5-50% higher, or 5-30% higher, than the amount of third hardened mixture in the first vein portion.

In some embodiments of the third aspect, the third hardened mixture extends only partially through the thickness of the slab, therefore, being exposed in the first major slab surface, but not in the second major slab surface.

In some embodiments, both the second hardened mixture and the third hardened mixture are exposed on the first major slab surface. In some embodiments, the second hardened mixture is exposed both in the first mayor slab surface and in the second major slab surface, while the third hardened mixture is exposed in the first major slab surface, but not in the second major slab surface.

In some embodiments of the third aspect, the first vein portion in the first major slab surface comprises the third hardened mixture at least partially surrounded by the second hardened mixture, such as on both opposed sides of the third hardened mixture through the width of the first vein portion.

In some embodiments, the slab of artificial agglomerate material may have an apparent density in the range from 2000kg/m 3 -2600 kg/m3, or from 2100kg/m3 -2500 kg/m3. Apparent density can be measured for example according to EN 14617-1:2013-08.

In a fourth aspect, the disclosure provides the use of a slab for the manufacture of a kitchen or vanity countertop, kitchen splashback, shower tray, wall or floor covering, furniture cladding, tabletop, ventilated façade tile, stovetop, stair step, or fireplace comprising or made from a slab according to any embodiment of the third aspect. The manufacture of these articles may include cutting the slab, leaving the slab edge exposed.

### DESCRIPTION OF THE DRAWINGS

These and other features and advantages of the different aspects covered in this disclosure will be seen more clearly from the following detailed description of an embodiment provided only by way of illustrative and non-limiting example in reference to the attached drawings.

FIG. 1 This figure shows a schematic representation of a first layer of a first mixture dispensed on top of a first surface, wherein one groove having one first groove region is created, extending through the thickness of the first layer.

FIG. 2 This figure shows the first layer of FIG. 1, wherein a second mixture, different from the first mixture, has been dispensed into the first groove region of the groove.

FIG. 3 This figure shows the first layer of FIGS. 1-2, where a third mixture, different from the first and second mixtures, has been dispensed into the first groove region, overlapping over the second mixture.

FIG. 4 This figure shows a representation of a slab, e.g. as obtained after compacting and hardening the combinations of mixtures according to the embodiment of FIGS. 1-3.

### DETAILED DESCRIPTION OF EMBODIMENTS

As will be appreciated by one skilled in the art, aspects of the present disclosure may be embodied as method, system for application of the method for manufacturing the product, or product directly obtained from the method for manufacturing the product, or by using the production system.

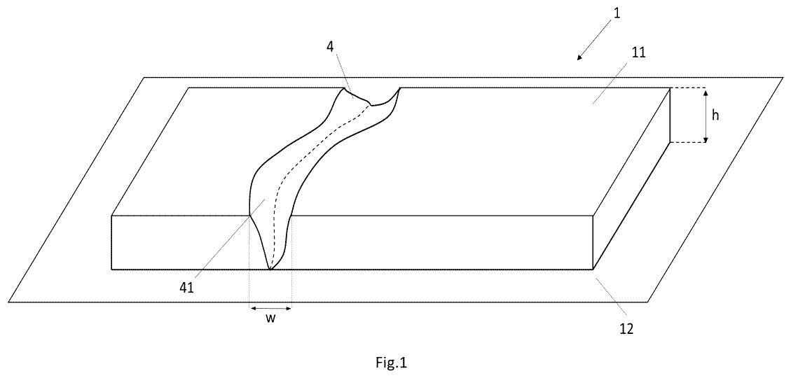

FIG. 1 shows a first layer (1) of a first mixture (11) having been dispensed by a first dispenser (not shown) onto a first surface (12), e.g. of paper kraft. The first mixture (11) is previously prepared in a first mixer (not shown) in the form of a planetary mixer, by mixing 85-95 wt % or a first particulate material and 5-15 wt % of a first binder, both in relation to the weight of the first mixture (11). The first particulate material comprises different amounts of granulates and powders, having different particle sizes, of one or several of quartz, synthetic cristobalite, feldspar and recycled silicate glass. The first binder comprises a liquid translucent unsaturated polyester resin. The first mixture (11) also comprises from 0.5-3.0 wt % of first colorant mixture and additives comprising coupling agents, catalysts, accelerants, among others.

The dispensing of the first mixture (11) to form the first layer (1) is performed in a first dispensation station (not shown), by moving the first dispenser (not shown) over and along the length of the first surface (12), while discharging the first mixture (11) from a hoper along the width of the first layer (1) being dispensed. The thickness (h) of the first layer (1) is essentially homogeneous through its length and width, and can be set to different values depending on the thickness of the slab being manufactured. The length, width and thickness of the first layer (1) exceeds slightly to the dimensions of the slab being manufactured, to take into account the shrinking that the first mixture might suffer during the subsequent steps of the manufacturing process, such as compaction and hardening.

In the embodiment shown in FIG. 1, a groove (4) comprising a first groove region (41) is created in the first layer (1) of first mixture (11) with a first grooving device (not shown). The first grooving device, in this case, is a rotatable wheel-shaped indenter mounted on a robotic arm, that is inserted into the thickness (h) of the first layer (1) and its translated and rolled to follow the desired path of the groove (4). The first groove region (41), and the groove (4), in the embodiment herein, both have a width (w) at their part more distal from the first surface (12) that ranges 20-40 mm. The width (w) of the first groove region (41), in this embodiment, varies along the thickness (h) of the first layer (1). In this case, the width (w) of the first groove region (41) increases moving away from the first surface (12). Once the groove (4) and the first groove region (41) of the desired shape are created, the robotic device may separate the indenter from the first layer (1), e.g. by raising it.

In embodiments not shown, the process may be repeated as desired, to create any number of grooves and any combination of their paths and shapes.

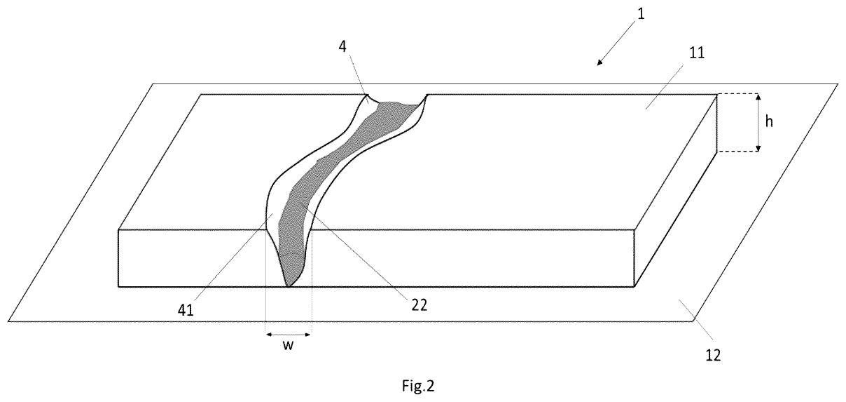

FIG. 2 shows an embodiment in which, in a second dispensation station (not shown) downstream the first dispensation station, a second dispenser (not shown) mounted on a first robotic device (not shown) dispenses a second mixture (22) into the first groove region (41) of the groove (4). The second mixture (22) is previously prepared in a second mixer (not shown) by combining 85-95 wt % of a second particulate material and 5-15 wt % of a second binder, both based on the weight of the second mixture (22). The second particulate material comprises different amounts of granulates and powders, having different particle sizes, of one or several of quartz, synthetic cristobalite, feldspar and recycled silicate glass. The second binder comprises a liquid translucent unsaturated polyester resin. The second mixture (22) also comprises from 0.5-3.0 % wt of a second colorant mixture and additives comprising coupling agents, catalysts, accelerants, among others, based on the weight of the second mixture (22).

The second dispenser comprises a hopper that receives the second mixture (22) from the second mixer in a top opening thereof and a conveyor belt positioned below a bottom outlet opening of the hopper, which collects and/or extracts the second mixture (22) from the hopper and transports it towards a dispensing area, where a funnel is arranged to focus the dispensation of the second mixture (22) into the first groove region (41) of the groove (4). The second dispenser is mounted on a first robotic device, which during dispensation of the second mixture (22) translates the second dispenser over the first layer (1) following the path of the first groove region (41) and of the groove (4).

The second mixture (22) is dispensed by the second dispenser in controlled variable amounts along the groove (4) and along the first groove region (41). The dispensing of the second mixture (22) by the second dispenser is predominantly made into the groove (4). In embodiments not shown, it is possible to dispense the second mixture (4) also partially outside the groove (4), for example 1-15 wt %, or 1-10 wt % of the second mixture (22), outside the groove (4). The filling degree of the different zones of the groove (4) and/or first groove region (41) can be adjusted. Thus, in the embodiments shown, the second mixture (22) occupies around 35 % (v/v) of the volume of the groove (4) or the first groove region (41).

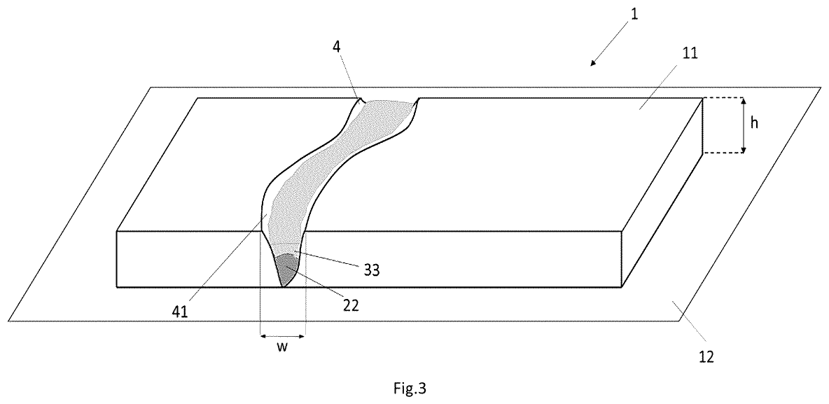

In the embodiment shown in FIG. 3, in a third dispensation station (not shown) downstream from the second dispensation station, a third mixture (33) is dispensed by a third dispenser (not shown) into the first groove region (41) of the groove (4). The third mixture (33) is previously prepared in a third mixer (not shown) by combining 85-95 wt % of a third particulate material and 5-15 wt % of a third binder, both based on the weight of the third mixture (33). The third particulate material comprises different amounts of granulates and powders, having different particle sizes, of one or several of quartz, synthetic cristobalite, feldspar and recycled silicate glass. The third binder comprises a liquid translucent unsaturated polyester resin. The third mixture (33) also comprises from 0.5-3.0 wt % of a third colorant mixture and additives comprising coupling agents, catalysts, accelerants, among others.

The components of the first (11), second (22) and third (33) mixtures are selected so that the first (11), second (22) and third (33) mixtures are all different, and/or they are visually distinguishable after hardening.

The third dispenser may be similar to the second dispenser and may comprise similarly a hopper, a conveyor belt and a funnel for the focused dispensation of the third mixture into the groove (4) and the first groove region (41). The third dispenser is mounted on a second robotic device (not shown), which during dispensation of the third mixture (33) translates the third dispenser over the first layer (1) following the path of the partially filled first groove region (41), as it dispenses the third mixture (33) into the first groove region (41). The filling degree of the different zones of the groove (4) and/or first groove region (41) with the third mixture (33) can be adjusted. Thus, in the embodiments shown, the third mixture (33) occupies around 25 % (v/v) of the volume of the groove (4) or the first groove region (41).

In the embodiment shown in FIG. 3, the filling degree of the first groove region (41), with the added amounts of second (22) and third (33) mixtures, is approximately 50 % v/v. The third mixture (33) is dispensed over the second mixture (22) already dispensed in the first groove region (41), in this case, to form differentiated layers. The layers of second (22) and third (33) mixtures are in direct contact and overlap more than 80 %, measured as the projection of both layers on the first surface (12) along the thickness (h) direction of the first layer (1). The third mixture (33) is dispensed so that it does not extend fully through the depth of the first groove region (41), and/or that it does not come into direct contact with the first surface (12). In other words, the third mixture (33) in not dispensed into the whole thickness (h) of the first layer (1).

In subsequent steps not shown in the Figures, the combination of first (11), second (22) and third (33) mixtures is covered with a protective sheet on the exposed side of the first layer (1), e.g., with a sheet of Kraft paper, before it is transferred to a compaction station. The compaction station, in this embodiment, comprises a vacuum vibrocompaction press, where the air in the combination of mixtures is evacuated with simultaneous pressing under vibration. After compaction, the compacted combination of mixtures is transferred to a hardening station where it is hardened- or cured-in a hardening station for about 40-60 minutes at 70-110° C. After hardening, the artificial agglomerate material slab is obtained. The slab of artificial agglomerate material obtained is calibrated and trimmed to the desired final dimensions, e.g., of 3.3×1.6 m, and one of the two major slab surfaces is polished or brushed to enhance the appreciation of the chromatic effects created.

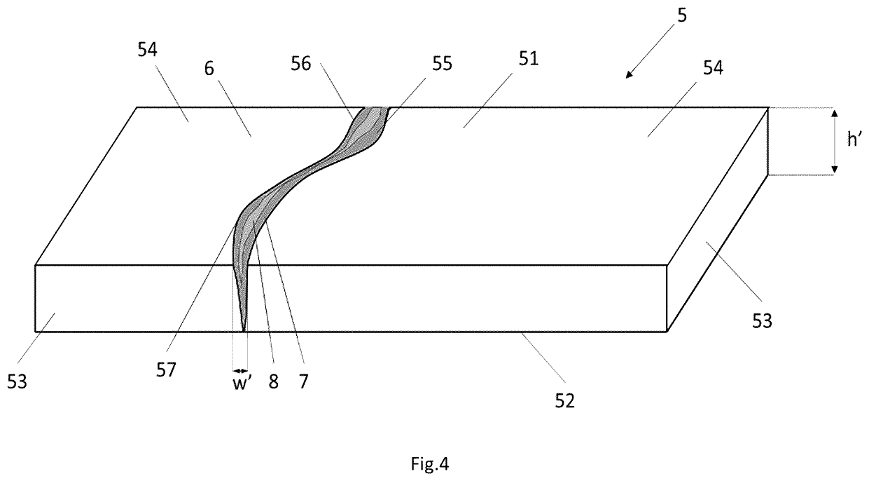

FIG. 4 depicts a representation of the slab (5), e.g. as obtained after compacting and hardening the combinations of mixtures according to the embodiments of FIGS. 1-3. The slab (5) comprises a first major slab surface (51) and a second major slab surface (52). Two of the four edges (53) of the slab are visible in FIG. 4.

A first pattern (54) and a second pattern (55) are exposed and visible on the first major slab surface (51) of the slab (5). The second pattern (55) defines a first vein (56) extending through the width of the slab (5). The first vein (56) comprises a first vein portion (57). In the embodiment of FIG. 4, both the first vein (56) and first vein portion (57) are elongated. The first vein portion (57) extends partially through the thickness (h′) of the slab (5). According to the representation in FIG. 4, the first vein portion (57) is visible on two opposed edges (53) of the slab (5).

The first pattern (54) comprises a first hardened mixture (6). The first hardened mixture (6) results from the hardening of the first mixture (11). As such, it comprises 85-95 wt % of the first particulate material and 5-15 wt % of the first hardened binder, with the compositions referred above for the first mixture (11).

The first vein portion (57) comprises a second hardened mixture (7) and a third hardened mixture (8), corresponding respectively to the second mixture (22) and third mixture (33) after hardening. The second mixture comprises 85-95 wt % of the second particulate material and 5-15 wt % of a second hardened binder, whereas the third hardened mixture (8) comprises 85-95 wt % of the third particulate material and 5-15 wt % of a third hardened binder.

The first (6), second (7) and third (8) hardened mixtures are all different, and in this embodiment, they present a different coloration.

The vacuum vibrocompaction and hardening of the combination of mixtures causes the closing of the partially filled first groove region (41), by bringing closer together the opposed walls of the groove (4). The arrangement of the different mixtures in this embodiment, the amounts used for the partial filling of the groove (4), and the vacuum vibrocompaction, causes the reorganization of the second (7) and third (8) mixtures in the slab (5) obtained. As seen in FIG. 4, after this reorganization, the third hardened mixture (8) is exposed on the first major slab surface (51), at least partially surrounded by the second hardened mixture (7) exposed on both opposed sides through the width (w′) of the first vein portion (57).

The third hardened mixture (8) is exposed and visible on at least one edge (53) of the slab (5) produced.

In the embodiments shown, the third hardened mixture (8) in the first vein portion (57) is exposed at the edge (53) of the slab (5) as produced or after the slab (5) is cut. The third hardened mixture (8) exposed at the edge (53) is at least partially surrounded by the second hardened mixture (7), which is also exposed on the edge (53), on both sides of the third hardened mixture (8) opposed through the width (w′) of the first vein portion (57). The third hardened mixture (8) in the slab (5) obtained, as shown in FIG. 4, does not extend through the full thickness (h′) of the slab (5). In these embodiments, the third hardened mixture (8) is not exposed through the second major slab surface (52), while the second hardened mixture (7) may or may not be exposed on this second major slab surface (52).

The artificial agglomerate material slab (5) has an apparent density in the range from 2000 kg/m3-2600 kg/m3, or from 2100 kg/m3-2500 kg/m3. Apparent density can be measured according to EN 14617-1:2013-08.

The water absorption of the artificial agglomerate material slab (5), for example, does not exceed 0.10 %, or 0.07%, or 0.05%, according to EN-14617-1:2013.

The artificial agglomerate material slab (5) might be used for construction or decoration, for manufacturing counters, kitchen countertops, sinks, shower trays, wall or floor coverings, stairs or similar.

1. A method for manufacturing a slab of artificial agglomerate material comprising the following steps:
a) dispensing a first layer of a first mixture onto a first surface the first mixture comprising 85-95 wt % of a first particulate material and 5-15 wt % of a first binder material, the first layer having a first thickness h;
b) creating at least one groove in the first layer extending at least partially through the first thickness h of the first layer, the at least one groove comprising one first groove region,
c) dispensing a second mixture comprising 85-95 wt % of a second particulate material and 5-15 wt % of a second binder material into the first groove region; and wherein
d) dispensing into the first groove region a third mixture comprising 85-95 wt % of a third particulate material and 5-15 wt % of a third binder material; and
e) compacting and hardening the combination of first, second and third mixtures,
wherein the first mixture, the second mixture, and the third mixture being all different mixtures.

2. The method according to claim 1, wherein the second mixture and/or the third mixture is/are disaggregated before it/they is/are dispensed into the first groove region.

3. The method according to claim 1, wherein the third mixture is dispensed over the second mixture previously dispensed in the first groove region, forming separated layers.

4. The method according to claim 3, wherein the third mixture does not contact the first surface.

5. The method according to claim 1, wherein the second mixture and third mixture both form layers, whose projections onto the first surface, along the thickness direction of the first layer, overlap in 30-100%.

6. The method according to claim 1, wherein the first groove region has an elongated shape with a length of at least 5 times, or at least 10 times, its average width.

7. The method according to claim 1, wherein the second mixture and/or the third mixture each fills less than 60% v/v of the volume of the cavity defined by the first groove region.

8. The method according to claim 1, wherein the added amounts of second mixture and third mixture fills less than 90% v/v of the volume of the cavity defined by the first groove region.

9. The method according to claim 1, wherein the weight amount of second mixture dispensed into the first groove region is 1-50% higher than the weight amount of the third mixture.

10. A system for the manufacture of slabs of artificial agglomerate material, configured for implementing the method of claim 1, the system comprising:
a first mixer configured for providing a first mixture comprising 85-95 wt % of a first particulate material and 5-15 wt % of a first binder;
a first dispenser suitable for dispensing a first layer of the first mixture on a first surface;
a first grooving device configured for the creation of at least one groove extending at least partially in the first layer, the at least one groove comprising one first groove region;
a second mixer configured for providing a second mixture comprising 85-95 wt % of a second particulate material and 5-15 wt % of a second binder;
a second dispenser suitable for the dispensation of the second mixture, the second dispenser being mounted on a first robotic device which is configured to move the second dispenser to the first groove region;
a compacting station; and
a hardening station,
wherein the system further comprises:
a third mixer configured for mixing a third mixture comprising 85-95 wt % of a third particulate material and 5-15 wt % of a third binder;
a third dispenser for the dispensation of the third mixture the third dispenser being mounted on
a second robotic device configured to move the third dispenser to the first groove region;
the first, second and third mixers being all different mixers.

11. The system according to claim 10, wherein the second dispenser and/or the third dispenser comprise/s a disaggregating device for disaggregating the second mixture or the third mixture respectively.

12. A slab of an artificial agglomerate material manufactured according to the method of claims 1 comprising:
a first major slab surface and a second major slab surface,
the first major slab surface comprising at least one vein extending at least partially through the thickness of the slab and the first major slab surface comprising a first hardened mixture, the first hardened mixture comprising 85-95 wt % of a first particulate material and 5-15 wt % of a first hardened binder,
the at least one vein comprising a first vein portion exposed on the first major slab surface, wherein the first vein portion is extending at least partially through the thickness of the slab,
the first vein portion comprising a second hardened mixture the second hardened mixture comprising 85-95 wt % of a second particulate material and 5-15 wt % of a second hardened binder, wherein
the first vein portion further comprises a third hardened mixture, the third hardened mixture comprising 85-95 wt % of a third particulate material and 5-15 wt % of a third hardened binder,
the first, second and third hardened mixtures being different.

13. The slab of artificial agglomerate material of claim 12, wherein the first vein portion has an elongated shape, with its length at least 5 times its average width.

14. The slab of artificial agglomerate material according to claim 12, wherein the third hardened mixture extends only partially through the thickness of the slab therefore, being exposed in the first major slab surface but not in the second major slab surface.

15. The slab of artificial agglomerate material according to claim 12, wherein the first vein portion of the first major slab surface comprises third hardened mixture at least partially surrounded by the second hardened mixture, such as on both opposed sides, through the width (w′) of the first vein portion.
